(19) United States
(12) Patent Application Publication
(10) Pub. No.: US 2018/0124012 A1
(43) Pub. Date: May 3, 2018

(54) DOMAIN NAME SYSTEM (DNS) RESOLUTION PROCESSING METHOD AND DEVICE

(71) Applicant: ZTE CORPORATION, Guangdong (CN)

(72) Inventor: Yichao MENG, Guangdong (CN)

(73) Assignee: ZTE CORPORATION, Guangdong (CN)

(21) Appl. No.: 15/570,079

(22) PCT Filed: Oct. 16, 2015
(86) PCT No.: PCT/CN2015/092129

§ 371 Date: Oct. 27, 2017

(30) Foreign Application Priority Data
May 12, 2015 (CN) 201510240494.5

(51) Int. Cl. H04L 29/12; H04L 12/741

(52) U.S. Cl. CPC H04L 61/2015; H04L 61/10; H04L 61/1511; H04L 45/74

(57) ABSTRACT

The present disclosure provides a domain name system (DNS) resolution processing method and device. The method comprises: a router writes a primary DNS resolution server IP address obtained through dialing into a secondary DNS resolution server IP address parameter of a DHCP server process configuration file; and the router receives a DHCP request from a terminal and assigns the primary DNS resolution server IP address of the router to the secondary DNS resolution server IP address of the terminal. The problem that the DNS resolution proxy process of the router device cannot perform resolution, causing the user unable to access the Internet, can be solved, ensuring the normal resolution of the user DNS request, improving the quality at which the user uses the router device to conduct network services.

### CROSS REFERENCE

The present application is an US national phase of International Application No. PCT/CN2015/092129, filed on Oct. 16, 2015, which is based upon and claims priority to Chinese Patent Application No. 201510240494.5, filed on May 12, 2015, and the entire contents thereof are incorporated herein by reference.

### TECHNICAL FIELD

The disclosure relates to the field of communications, and in particular, to a domain name system (DNS) resolution processing method and device.

### BACKGROUND

When using devices like Customer Premise Equipment (referred to as CPE) to access the Internet, especially when multiple users conduct network services frequently at the same time, there will suddenly be no Internet access, but if a detection is performed at the time using network diagnostic tools or diagnostic commands, it will be found that the network link is connected if the detection is performed using the IP address as the target, while the network link is not connected if the detection is performed using the domain name as the target. After verification, it can be determined that the common cause of the failure to access the Internet is that the buffer of the Domain Name System (referred to as DNS) proxy server process of a router device is full and cannot accept a new DNS request. It is to be noted that the buffer is calculated through a set of fixed algorithms, not easy to modify. The buffer is not full in normal circumstances, unless a lot of frequent DNS requests from users are not answered. Therefore, as the DNS proxy server of a routing equipment like CPE works in disorder, even other functions of the equipment are normal, a lot of troubles are still caused to users, equipment manufacturers and operators, resulting in complaints.

At present, there is still no effective solution proposed in the relevant art to solve the problem that the domain name system (DNS) resolution proxy process of a router device cannot perform resolution, causing the user unable to access the Internet.

This section provides background information related to the present disclosure which is not necessarily prior art.

### SUMMARY

The present disclosure provides a domain name system (DNS) resolution processing method and device to solve at least the problem that the DNS resolution proxy process of a router device cannot perform resolution in the related technology, causing a user unable to access the Internet.

According to an embodiment of the present disclosure, there is provided a DNS resolution processing method including:

a router writing a primary DNS resolution server IP address obtained through dialing into a secondary DNS resolution server IP address parameter of a DHCP server process configuration file;

the router receiving a DHCP request from a terminal and assigning the primary DNS resolution server IP address of the router to the secondary DNS resolution server IP address of the terminal.

In an embodiment of the present disclosure, said assigning the primary DNS resolution server IP address of the router to the secondary DNS resolution server address of the terminal includes one of the following:

a DHCP server of the router assigning the primary DNS resolution server IP address of the router to the secondary DNS resolution server IP address of the terminal.

In an embodiment of the present disclosure, the method further includes:

in a case where the router successfully accesses the Internet through dialing, the router writing the primary DNS resolution server IP address into the secondary DNS resolution server IP address parameter of the router of a DHCP service process.

In an embodiment of the present disclosure, the router writing the primary DNS resolution server IP address obtained through dialing into the secondary DNS resolution server IP address parameter of the DHCP server process configuration file includes:

initializing a configuration parameter modification flag bit of the DHCP service process;

closing the DHCP service process, and writing the obtained primary DNS resolution server IP address into the secondary DNS resolution server IP address parameter of the router DHCP service process;

setting the configuration parameter modification flag bit of the DHCP service process to be a specified value;

detecting whether the configuration parameter modification flag bit of the DHCP service process is the specified value, if so, restarting the DHCP process and resetting the flag bit.

In an embodiment of the present disclosure, the method includes:

when the terminal sends the DNS proxy process of the router, when the DNS resolution proxy process of the router works in disorder, the terminal sending the DNS request to the secondary DNS of the terminal to complete a DNS resolution, wherein the secondary DNS is the primary DNS of the router.

According to another embodiment of the present disclosure, there is further provided a DNS resolution processing device including:

a write module configured so that the router writes the primary DNS resolution server IP address obtained through dialing into the secondary DNS resolution server IP address parameter of the DHCP server process configuration file;

an assigning module configured so that the router receives a DHCP request from a terminal and assigns the primary DNS resolution server IP address of the router to the secondary DNS resolution server IP address of the terminal.

In an embodiment of the present disclosure, the assigning module includes:

a first assigning unit configured so that a DHCP server of the router assigns the primary DNS resolution server IP address of the router to the secondary DNS resolution server IP address of the terminal.

In an embodiment of the present disclosure, the device further includes:

a dialing module configured so that, in a case where the router successfully accesses the Internet through dialing, the router writes the primary DNS resolution server IP address into the secondary DNS resolution server IP address parameter of the router of a DHCP service process.

In an embodiment of the present disclosure, the write module includes:

an initialization unit configured to initialize a configuration parameter modification flag bit of the DHCP service process;

a write unit configured to close the DHCP service process, and write the obtained primary DNS resolution server IP address into the secondary DNS resolution server IP address parameter of the router DHCP service process;

a setting unit configured to set the configuration parameter modification flag bit of the DHCP service process to be a specified value;

a detection unit configured to detect whether the configuration parameter modification flag bit of the DHCP service process is the specified value, if so, restart the DHCP process and reset the flag bit.

In an embodiment of the present disclosure, the device includes:

a resolving module configured so that, when the terminal sends the DNS proxy process of the router, when the DNS resolution proxy process of the router works in disorder, the terminal sends the DNS request to the secondary DNS of the terminal to complete a DNS resolution, wherein the secondary DNS is the primary DNS of the router.

With the disclosure, by means of the router writing the primary DNS resolution server IP address obtained through dialing into the secondary DNS resolution server IP address parameter of the DHCP server process configuration file, the router receiving the DHCP request from the terminal, assigning the primary DNS resolution server IP address of the router to the secondary DNS resolution server IP address of the terminal, the problem that the DNS resolution proxy process of the router device cannot perform resolution, causing the user unable to access the Internet, can be solved, ensuring the normal resolution of the user DNS request, improving the quality at which the user uses the router device to conduct network services.

This section provides a summary of various implementations or examples of the technology described in the disclosure, and is not a comprehensive disclosure of the full scope or all features of the disclosed technology

### BRIEF DESCRIPTION OF THE DRAWINGS

The accompanying drawings described hereinabove provide a further understanding of the disclosure and constitute a part of this disclosure, and the illustrative embodiments of the disclosure and the description thereof are intended to be illustrative of the disclosure and are not to be construed as limiting the disclosure. In the drawings:

FIG. 1 is a flow chart of a DNS resolution processing method according to an embodiment of the present disclosure;

FIG. 2 is a block diagram of the structure of a DNS resolution processing device according to an embodiment of the present disclosure;

FIG. 3 is a schematic flow chart of a DNS resolution optimization mechanism according to a preferred embodiment of the present disclosure;

FIG. 4 is a schematic flow chart of the implementation of an initialization module according to a preferred embodiment of the present disclosure;

FIG. 5 is a schematic flow chart of the implementation of a DHCP parameter configuration module according to a preferred embodiment of the present disclosure;

FIG. 6 is a schematic flow chart of the implementation of a DHCP process management module according to a preferred embodiment of the present disclosure.

### DETAILED DESCRIPTION

Hereinafter, the present disclosure will be described in detail with reference to the accompanying drawings combining embodiments. It is to be noted that the embodiments and the features in the embodiments in the present application may be combined with each other without conflict.

It is to be understood that the terms “first”, “second” and the like in the description, claims and accompanying drawings of the present disclosure are used for distinguishing similar objects and need not be used to describe a particular order or sequence.

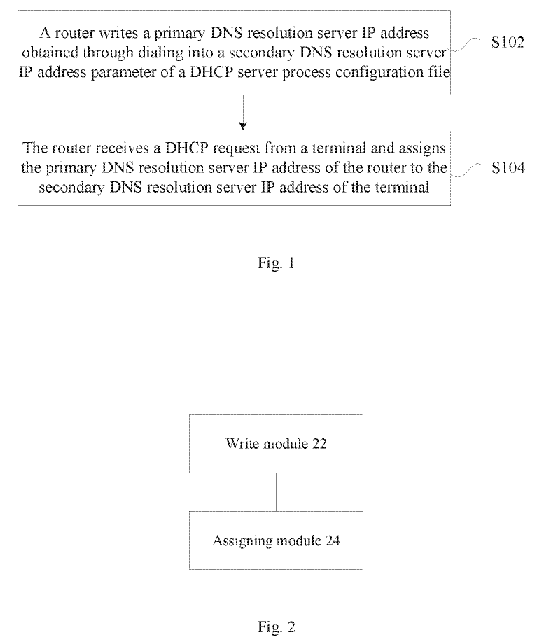

Provided in the embodiments is a DNS resolution processing method. FIG. 1 is a flow chart of a DNS resolution processing method according to an embodiment of the present disclosure. As shown in FIG. 1, the flow includes the following steps:

step S102, a router writing a primary DNS resolution server IP address obtained through dialing into a secondary DNS resolution server IP address parameter of a DHCP server process configuration file;

step S104, the router receiving a DHCP request from a terminal and assigning the primary DNS resolution server IP address of the router to the secondary DNS resolution server IP address of the terminal.

With the steps described above, the router writing a primary DNS resolution server IP address obtained through dialing into a secondary DNS resolution server IP address parameter of a DHCP server process configuration file and the router assigning the primary DNS resolution server IP address of the router to the secondary DNS resolution server IP address of the terminal, utilize the resolution function of the secondary DNS of the user terminal equipment, solve the problem that the DNS resolution proxy process of the router device cannot perform resolution, causing users unable to access the Internet, and thereby ensure the normal resolution of the user DNS request, improving the quality at which the user uses the router device to conduct network services.

In the present embodiment, it may be the DHCP server of the router that automatically assigns the primary DNS resolution server IP address of the router to the secondary DNS resolution server IP address of the terminal.

In the present embodiment, in a case where the router successfully accesses the Internet through dialing, the router writes the primary DNS resolution server IP address obtained through dialing into the secondary DNS resolution server IP address parameter of a DHCP server process configuration file.

In the present embodiment, the router writing the primary DNS resolution server IP address into the secondary DNS resolution server IP address parameter of the router of the DHCP service process, includes:

initializing a configuration parameter modification flag bit of the DHCP service process;

closing the DHCP service process, and writing the obtained primary DNS resolution server IP address into the secondary DNS resolution server IP address parameter of the router DHCP service process;

setting the configuration parameter modification flag bit of the DHCP service process to be a specified value;

detecting whether the configuration parameter modification flag bit of the DHCP service process is the specified value, if so, restarting the DHCP process and resetting the flag bit.

In the above embodiment, when the terminal sends the DNS proxy process of the router, when the DNS resolution proxy process of the router works in disorder, the terminal sends the DNS request to the secondary DNS of the terminal to complete a DNS resolution, wherein the secondary DNS is the primary DNS of the router.

In the present embodiment, there is further provided a DNS resolution processing device located in a terminal. The device is used to implement the above-described embodiments and preferred embodiments which will not be described again. As used herein, the term “module” may implement a combination of software and/or hardware of a predetermined function. Although the device described in the following embodiments is preferably implemented in software, the implementation in hardware, or a combination of software and hardware, is also possible and envisioned.

FIG. 2 is a block diagram of the structure of a DNS resolution processing device according to an embodiment of the present disclosure, as shown in FIG. 2, the device including:

a write module 22 configured so that the router writes the primary DNS resolution server IP address obtained through dialing into the secondary DNS resolution server IP address parameter of the DHCP server process configuration file;

an assigning module 24 configured so that the router receives a DHCP request from a terminal and assigns the primary DNS resolution server IP address of the router to the secondary DNS resolution server IP address of the terminal.

Through the above device, the router writes the primary DNS resolution server IP address to the secondary DNS resolution server IP address parameter of the router of the Dynamic Host Configuration Protocol (DHCP) service process, and assigns the primary DNS resolution server IP address of the router to the secondary DNS resolution server IP address of the terminal, utilizes the resolution function of the secondary DNS of the user terminal equipment, solves the problem that the DNS resolution proxy process of the router device cannot perform resolution, which causes users unable to access the Internet, ensures the normal resolution of the user DNS request, and improves the quality at which the user uses the router device to conduct network services.

In the present embodiment, the assigning module 24 includes:

a first assigning unit configured so that a DHCP server of the router assigns the primary DNS resolution server IP address of the router to the secondary DNS resolution server IP address of the terminal.

In the present embodiment, the device further includes:

a dialing module configured so that, in a case where the router successfully accesses the Internet through dialing, the router writes the primary DNS resolution server IP address into the secondary DNS resolution server IP address parameter of the router of a DHCP service process.

In the present embodiment, the write module 22 includes:

an initialization unit configured to initialize a configuration parameter modification flag bit of the DHCP service process;

a write unit configured to close the DHCP service process, and write the obtained primary DNS resolution server IP address into the secondary DNS resolution server IP address parameter of the router of the DHCP service process;

a setting unit configured to set the configuration parameter modification flag bit of the DHCP service process to be a specified value;

a detection unit configured to detect whether the configuration parameter modification flag bit of the DHCP service process is the specified value, if so, restart the DHCP process and reset the flag bit.

In the present embodiment, the device further includes:

a resolving module configured so that, when the terminal sends the DNS proxy process of the router, when the DNS resolution proxy process of the router works in disorder, the terminal sends the DNS request to the secondary DNS of the terminal to complete a DNS resolution, wherein the secondary DNS is the primary DNS of the router.

The present disclosure will now be described in detail with reference to preferred embodiments.

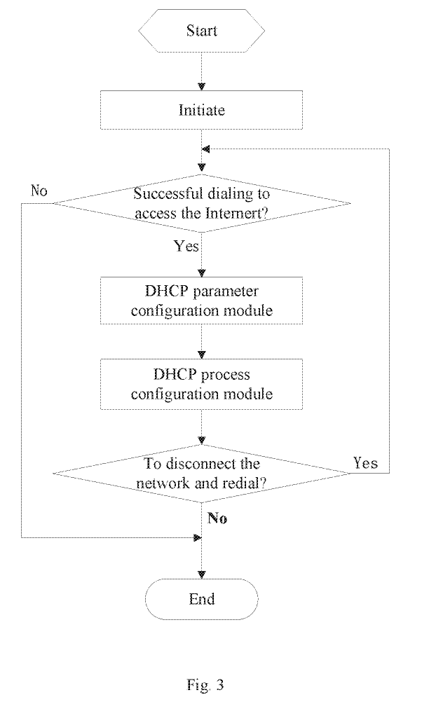

FIG. 3 is a schematic flow chart of a DNS resolution optimization mechanism according to a preferred embodiment of the present disclosure. As shown in FIG. 3, in the preferred embodiment of the present disclosure, by modifying the configuration parameters of the DHCP server (Server) of the router device, the router writes the primary DNS resolution server IP address obtained through dialing to the secondary DNS resolution server IP address parameter of the DHCP server process configuration file. When the terminal device accessing the router device issues a DHCP request to the router device by means of DHCP, the DHCP server of the router assigns the primary DNS resolution server IP address, obtained through dialing to access the Internet, to the secondary DNS resolution server IP address of the terminal device. Thus when the DNS proxy server of the router device cannot work, the user's DNS request is normally resolved through the secondary DNS resolution server of the terminal device, without the need for any operation from the user. Therefore, this can further ensure the correctness of DNS resolution, reduce unnecessary trouble, and improve user experience.

The preferred embodiment of the disclosure provides a DNS resolution optimization mechanism and device for the purpose of, by modifying the configuration parameters of the DHCP service of the router device such as CPE and UFI, writing the the primary DNS resolution server IP address obtained through dialing by the router device into the secondary DNS resolution server IP address parameter of the DHCP Service of the router device, thereby assigning it to the secondary DNS resolution server address of the user terminal device by means of DHCP. Thus, when the DNS proxy server of the router device such as CPE and UFI cannot work, the DNS request of the user terminal device can be normally resolved. The DNS request of the device can be resolved properly, thereby effectively ensuring the quality of the user's access to the Internet, avoiding a lot of unnecessary trouble.

Part of steps of the implementation of a preferred embodiment are as follows:

Step 1, initialization. Clear up the configuration parameter modification flag bit of the DHCP Service.

Step 2, determining whether the dialing is successful, if so, closing the DHCP process, and writing the primary DNS resolution server IP address obtained through dialing to access the Internet into the secondary DNS resolution server IP address parameter of the DHCP server process configuration file (Service) of the router device. The configuration parameter modification flag bit is set to be 1.

Step 3, the DHCP management module detecting whether the DHCP service configuration parameter modification flag bit is 1, if so, restarting the DHCP process and resetting the flag to be 0.

Step 4, then determining whether to disconnect the network and re-dial, if so, repeating step 2 to start a next round of operations.

The technical solution of the preferred embodiment is simple to implement with obvious effect, and can solve the problem that the DNS proxy server of the routing device cannot work so that the user cannot access the Internet, effectively ensuring the quality at which the user uses the router device to conduct the network service, also greatly improving user experience.

The preferred embodiment of the present disclosure includes the following modules: an initialization module, a DHCP parameter configuration module, and a DHCP process management module.

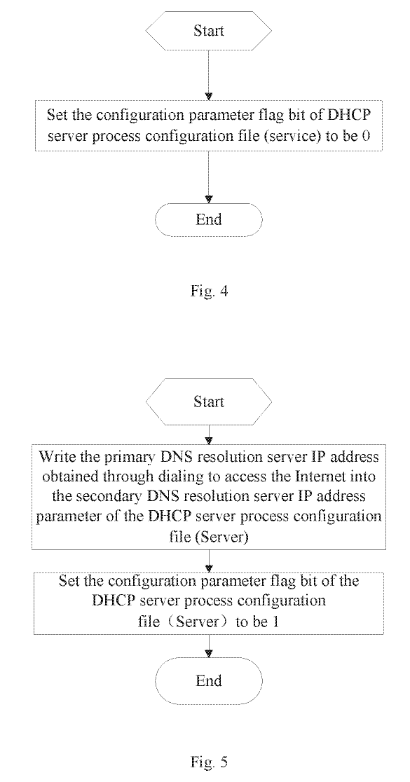

FIG. 4 is a schematic flow chart of the implementation of an initialization module according to a preferred embodiment of the present disclosure, as shown in FIG. 4, as step 1 described above.

FIG. 5 is a schematic flow chart of the implementation of a DHCP parameter configuration module according to a preferred embodiment of the present disclosure, as shown in FIG. 5, as step 2 described above.

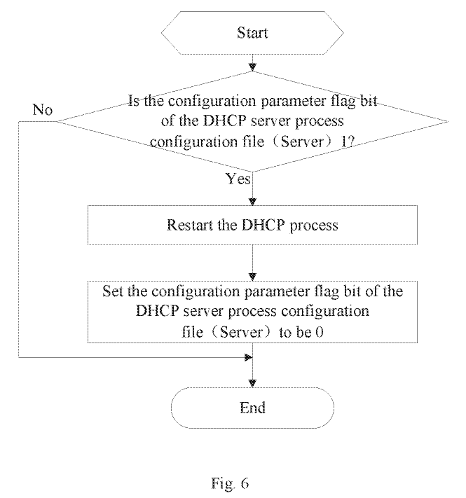

FIG. 6 is a schematic flow chart of the implementation of a DHCP process management module according to a preferred embodiment of the present disclosure, as shown in FIG. 6, as step 3 described above.

In the preferred embodiment of the present disclosure, the DNS resolution optimization scheme described in the above solution can be replaced so that every time the dialing made by the router device is successful, the user can log in the device to view and dial to access the Internet through a management page or telnet or adb to obtain the primary DNS resolution server IP Address, and then manually configure it to the secondary DNS resolution server IP address of the network card of the user terminal equipment.

The technical solution adopted by the preferred embodiment of the present disclosure, by writing the primary DNS resolution server IP address obtained through each successful dialing into the secondary DNS resolution server IP address parameter of the DHCP server process configuration file (Server) and by assigning it to the secondary DNS resolution server address of the user terminal equipment, can effectively solve the problem that the DNS of the routing device cannot perform resolution so that the user cannot access the Internet, give full play to the secondary DNS resolution function of the user terminal equipment, ensuring the normal resolution of the user's DNS request, further ensuring the quality at which the user uses the router device to conduct network services.

With the description of the above embodiments, it will be apparent to those skilled in the art that the method according to the above embodiments can be implemented by means of software plus necessary general hardware platforms, and of course via hardware, though in many cases the former is better. Based on this understanding, the technical solution of the present disclosure essentially or a part thereof that contributes to the prior art may be embodied in the form of a software product, the computer software product is stored in a storage medium (such as ROM/RAM, magnetic disk, optical disc), including a number of instructions for enabling a terminal device (which may be a mobile phone, a computer, a server, or a network device, etc.) to perform the method of various embodiments of the present disclosure.

Further provided in the embodiments of the present disclosure is a storage medium. Alternatively, in the present embodiments, the above-described storage medium may be configured to store program code for executing the above-described embodiments.

Alternatively, in the present embodiments, the above-described storage medium may include, but is not limited to, a USB disk, a read-only memory (ROM), a random access memory (RAM), a mobile hard disk, a magnetic disk or an optical disc and other media that can store the program code.

Alternatively, in the present embodiments, the processor executes the method of the above embodiments according to the program code stored in the storage medium.

It will be apparent to those skilled in the art that the above-described modules or steps of the present disclosure may be implemented by a general purpose computing device, and may be centralized on a single computing device or distributed over a network of multiple computing devices. Alternatively, they may be implemented using program code executable by the computing device, so that they may be stored in a storage device for execution by the computing device, and in some cases, the steps shown or described may be executed in a different order from the order shown here, or individual integrated circuit modules are made correspondingly, or multiple modules or steps therein are implemented by making a corresponding single integrated circuit module. Thus, the present disclosure is not limited to any particular combination of hardware and software.

The foregoing description is merely illustrative of the preferred embodiments of the present disclosure and is not intended to be limiting of the present disclosure. Various changes and modifications may be made by those skilled in the art. Any modifications, equivalent substitutions, improvements, and the like made within the spirit and principles of the disclosure are intended to be included within the scope of the present disclosure.

### INDUSTRIAL APPLICABILITY

With the technical solution provided in the embodiments of the present disclosure, the router writes the primary DNS resolution server IP address obtained through dialing into the secondary DNS resolution server IP address parameter of the DHCP server process configuration file, the router receives the DHCP request from the terminal, assigns the primary DNS resolution server IP address of the router to the secondary DNS resolution server IP address of the terminal, and solves the problem that the DNS resolution proxy process of the router device cannot perform resolution so that the user cannot access the Internet, ensuring the normal resolution of the user's DNS request, improving the quality at which the user uses the router device to conduct network services.

1. A domain name system (DNS) resolution processing method, comprising:
writing, by a router, a primary domain name system (DNS) resolution server IP address obtained through dialing into a secondary DNS resolution server IP address parameter of a dynamic host configuration protocol (DHCP) server process configuration file; and
receiving, by the router, a DHCP request from a terminal and assigning the primary DNS resolution server IP address of the router to the secondary DNS resolution server IP address of the terminal.

2. The method according to claim 1, wherein said assigning the primary DNS resolution server IP address of the router to the secondary DNS resolution server address of the terminal comprises:
assigning, by a DHCP server of the router, the primary DNS resolution server IP address of the router to the secondary DNS resolution server IP address of the terminal.

3. The method according to claim 1, wherein the method further comprises
in a case where the router successfully accesses the Internet through dialing, writing, by the router, the primary DNS resolution server IP address into the secondary DNS resolution server IP address parameter of the router of a DHCP service process.

4. The method according to claim 1, wherein writing, by the router, the primary DNS resolution server IP address obtained through dialing into the secondary DNS resolution server IP address parameter of the DHCP server process configuration file comprises:
initializing a configuration parameter modification flag bit of the DHCP service process;
closing the DHCP service process, and writing the obtained primary DNS resolution server IP address into the secondary DNS resolution server IP address parameter of the router DHCP service process;
setting the configuration parameter modification flag bit of the DHCP service process to be a specified value;
detecting whether the configuration parameter modification flag bit of the DHCP service process is the specified value, if so, restarting the DHCP process and resetting the flag bit.

5. The method according to claim 1, wherein the method comprises:
when the terminal sends the DNS proxy process of the router, when the DNS resolution proxy process of the router works in disorder, sending, by the terminal, the DNS request to the secondary DNS of the terminal to complete a DNS resolution, wherein the secondary DNS is the primary DNS of the router.

6. A domain name system (DNS) resolution processing device comprising:
a write module configured so that the router writes the primary domain name system (DNS) resolution server IP address obtained through dialing into the secondary DNS resolution server IP address parameter of a dynamic host configuration protocol (DHCP) server process configuration file;
an assigning module configured so that the router receives a DHCP request from a terminal and assigns the primary DNS resolution server IP address of the router to the secondary DNS resolution server IP address of the terminal.

7. The device according to claim 6, wherein the assigning module comprises:
a first assigning unit configured so that a DHCP server of the router assigns the primary DNS resolution server IP address of the router to the secondary DNS resolution server IP address of the terminal.

8. The device according to claim 6, wherein the device further comprises:
a dialing module configured so that, in a case where the router successfully accesses the Internet through dialing, the router writes the primary DNS resolution server IP address into the secondary DNS resolution server IP address parameter of the router of a DHCP service process.

9. The device according to claim 6, wherein the write module comprises:
an initialization unit configured to initialize a configuration parameter modification flag bit of the DHCP service process;
a write unit configured to close the DHCP service process, and write the obtained primary DNS resolution server IP address into the secondary DNS resolution server IP address parameter of the router of the DHCP service process;
a setting unit configured to set the configuration parameter modification flag bit of the DHCP service process to be a specified value;
a detection unit configured to detect whether the configuration parameter modification flag bit of the DHCP service process is the specified value, if so, restart the DHCP process and reset the flag bit.

10. The device according to claim 1, wherein the device comprises:
a resolving module configured so that, when the terminal sends the DNS proxy process of the router, when the DNS resolution proxy process of the router works in disorder, the terminal sends the DNS request to the secondary DNS of the terminal to complete a DNS resolution, wherein the secondary DNS is the primary DNS of the router.

11. A non-transitory computer-readable storage medium storing instructions which, when executed by a processor, cause the processor to perform a method comprising:
writing, by a router, a primary domain name system (DNS) resolution server IP address obtained through dialing into a secondary DNS resolution server IP address parameter of a dynamic host configuration protocol (DHCP) server process configuration file; and receiving, by the router, a DHCP request from a terminal and assigning the primary DNS resolution server IP address of the router to the secondary DNS resolution server IP address of the terminal.
